(19) United States
(12) Patent Application Publication
(10) Pub. No.: US 2009/0209225 A1
(43) Pub. Date: Aug. 20, 2009

(54) Emergency Call System

(75) Inventors: Hiroshi Sakai, Toyota-city (JP); Takashi Shimizu, Gamagori-city (JP); Noriaki Ito, Toyota-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/224,400

(22) PCT Filed: Oct. 4, 2007
(86) PCT No.: PCT/JP2007/069460

§ 371 Date: Aug. 26, 2008

(30) Foreign Application Priority Data
Oct. 5, 2006 (JP) 2006-274335

(51) Int. Cl. H04M 11/04

(52) U.S. Cl. 455/404.1

(57) ABSTRACT

An emergency call system includes an emergency call control portion, a communication device, a change-over switch, and an electric current limit circuit. The emergency call control portion performs an emergency call to a center in an emergency of a vehicle. The communication device communicates with the center, wherein the communication device includes a speaker and a speaker amplifier for driving the speaker. The change-over switch changes a power supply source from a main power source to an auxiliary power source. The electric current limit circuit limits an electric current of the speaker amplifier when the change-over switch changes the power supply source to the auxiliary power source.

### CROSS REFERENCE TO RELATED APPLICATION

This application is based on and incorporates herein by reference Japanese Patent Application No. 2006-274335 filed on Oct. 5, 2006.

### TECHNICAL FIELD

The present invention relates to an emergency call system that performs an emergency call to a center in an emergency, such as a traffic accident or a failure of a vehicle, and sudden illness of an occupant.

### BACKGROUND ART

For example, JP-A-2002-152419 describes an emergency call system mounted on a vehicle. The emergency call system described in JP-A-2002-152419 performs a call transmission process by transmitting data, such as present position information and registered information, to a ground center that is under the authority of an emergency call system, such as a police, an emergency call center, through communication means in an emergency, such as a traffic accident and failure of a vehicle, sudden illness of an occupant. Thus, call through communication means, such as a hands-free phone device or a handset phone device, is made possible.

Specially in a case of the traffic accident or the failure among the above emergency, power supply from a main battery that serves as a main power source may be stopped due to failure or dropping of the main battery, breakage of a power supply line, etc, and thereby the power supply is performed through a back-up battery that serves as a auxiliary power source. In the case, because the back-up battery has a capacity smaller the main battery in general, and thereby the reduction in electric power consumption for the emergency call system is required. As a result, supply of the power to the communication means for communicating with the center is limited.

However, in the above emergency call system, when power supply by the back-up battery is performed in an emergency, failure may disadvantageously occur in the communication between the center and the occupant through a telephone set in the emergency because the supply of the power to the communication means is limited.

### SUMMARY OF THE INVENTION

The object of the present invention is made in view of the above disadvantages. Thus, it is an object of the present invention to address at least one of the above disadvantages.

To address the above disadvantages, there is provided an emergency call system, which includes emergency call means, communication means, change-over means, and electric current limiting means. The emergency call means performs an emergency call to a center in an emergency of a vehicle. The communication means communicates with the center, wherein the communication means includes sound output means and drive means for driving the sound output means. The change-over means changes a power supply source from a main power source to an auxiliary power source. The electric current limiting means limits an electric current of the drive means when the change-over means changes the power supply source to the auxiliary power source.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram showing one embodiment of an emergency call system according to the present invention;

FIG. 2 is a block diagram showing the one embodiment of the emergency call system according to the present invention; and

FIG. 3 is a flow chart showing a control process of the one embodiment of the emergency call system according to the present invention.

### DETAILED DESCRIPTION OF PREFERRED EMBODIMENTS

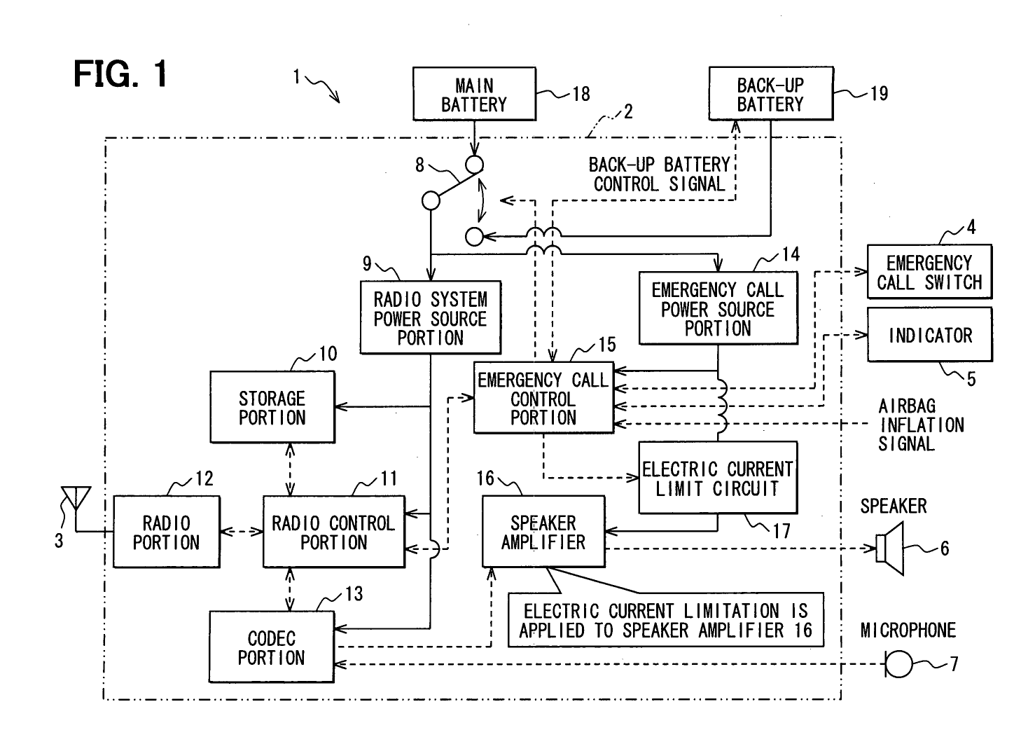

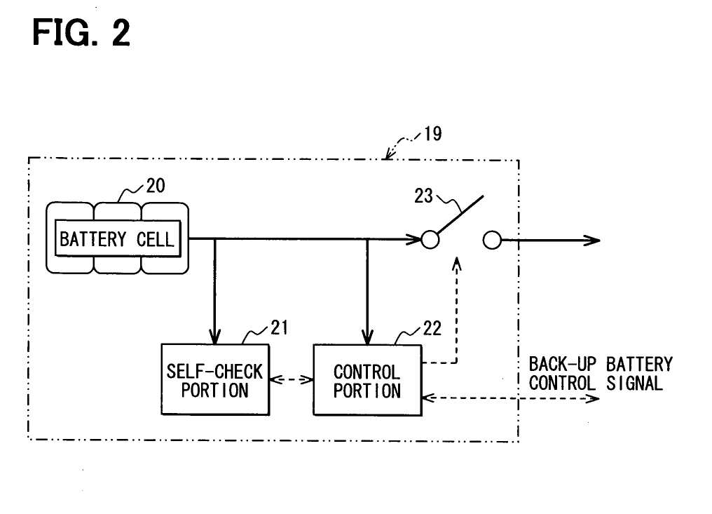

FIG. 1 a block diagram showing one embodiment of an emergency call system according to the present invention. Also, FIG. 2 is a block diagram showing one embodiment of a back-up battery that supplies power to the emergency call system of the present invention in an emergency.

An emergency call system 1 includes an emergency call ECU (Electronic Control Unit) 2, an antenna 3, an emergency call switch 4, an indicator 5, a speaker 6, and a microphone 7 as shown in FIG. 1. It is noted that an arrow with a thick line in FIG. 1 indicate a power supply line, and an arrow with a dashed line indicates a control signal line. Also, the emergency call switch 4, the indicator 5, the speaker 6, and the microphone 7 are provided in a vehicle cabin.

The emergency call ECU 2 includes, for example, a CPU, a ROM, a RAM and a data bus that provides connection therebetween, and the CPU executes certain processes described below in accordance with programs stored in the ROM. The emergency call ECU 2 includes a change-over switch 8, a radio system power source portion 9, a storage portion 10, a radio control portion 11, a radio portion 12, a CODEC portion 13, an emergency call power source portion 14, an emergency call control portion 15, a speaker amplifier 16, and an electric current limit circuit 17.

The change-over switch 8 has, as shown in FIG. 1, one terminal connected to a main battery 18 (main power source) and another terminal connected to a back-up battery 19 (auxiliary power source), and the change-over switch 8 constitutes change-over means that changes a power supply source supplied to the radio system power source portion 9 and the emergency call power source portion 14 from the main battery 18 to the back-up battery 19 based on a control signal from the emergency call control portion 15 in an emergency of the vehicle, for example, when the emergency call control portion 15 detects an airbag inflation signal, or when the occupant operates the emergency call switch 4.

The radio system power source portion 9 supplies electric power, which is supplied from the main battery 18 or the back-up battery 19, to the storage portion 10, the radio control portion 11, and the CODEC portion 13.

The storage portion 10 stores, based on a control by the radio control portion 11, registered information of the vehicle, a telephone number of each base station, and position information of the vehicle obtained by the radio control portion 11 from a car navigation device not shown here.

The radio portion 12 modulates and demodulates a high frequency radio wave signal received by the antenna 3 to generate a digital signal, and modulates and demodulates digital signals from the emergency call control portion 15 and the CODEC portion 13 to generate high frequency radio wave signals.

The radio control portion 11 gives the emergency call control portion 15 a digital signal having a control signal and gives the CODEC portion 13 a digital signal having a sound signal among the digital signals generated by the radio portion 12. Also, the radio control portion 11 generates digital signals based on the control signal from the emergency call control portion 15 and based on the sound signal from the CODEC portion 13 to supply the digital signals to the radio portion 12. Also, the radio control portion 11 makes the storage portion 10 store the vehicle position information obtained from the car navigation device, and changes over the telephone number of each base station based on the vehicle position information.

The CODEC portion 13 generates a sound signal based on the digital signal having the sound signal given by the radio control portion 11 to supply the signal to the speaker amplifier 16, and generates a digital signal based on a sound signal inputted through the microphone 7 to supply the signal to the radio control portion 11.

The emergency call power source portion 14 supplies the electric power supplied from the main battery 18 or the back-up battery 19 to the emergency call control portion 15, the electric current limit circuit 17, and the speaker amplifier 16.

The emergency call control portion 15 performs a transmission process using the telephone number of each base station to each base station that corresponds to a ground center, such as a police, an emergency call center, in an emergency of the vehicle in order to enable communication between the occupant and the center through a hands-free communication device (communication means) mainly including the speaker 6, the microphone 7, the speaker amplifier 16, and the CODEC portion 13 as components.

At the same time, the emergency call control portion 15 changes the power supply source from the main battery 18 to the back-up battery 19 by changing the change-over switch 8 in the emergency of the vehicle, for example, when the emergency call control portion 15 detects the airbag inflation signal, or when the occupant operates the emergency call switch 4. Also, the emergency call control portion 15 constitutes emergency call means that controls the radio control portion 11 to transmit the vehicle position information and the vehicle registered number to the ground center via the radio portion 12 and the antenna 3.

Note that, in a case of receiving the airbag inflation signal, it is assumed that the power supply through the main battery 18 has already been stopped at time of the reception, and therefore the emergency call control portion 15 has a built-in internal weak current operation circuit (PLD) that utilizes a capacitor in order to cover the power, supply during an interval for changing the power supply source to the back-up battery 19.

The speaker amplifier 16 constitutes drive means that amplifies the sound signal generated by the CODEC portion 13 to drive the speaker 6 (sound output means).

The electric current limit circuit 17 is provided between the emergency call power source portion 14 and the speaker amplifier 16, and the electric current limit circuit 17 constitutes electric current limiting means that limits an input electric current of the electric power supplied from the emergency call power source portion 14 to the speaker amplifier 16 based on the control by the emergency call control portion 15 in the emergency of the vehicle, for example, when the emergency call control portion 15 detects the airbag inflation signal, or when the occupant operates the emergency call switch 4. Various configurations, such as a DC/DC converter, a thermal shutdown circuit, a resistor circuit, may be employed as a specific configuration.

The back-up battery 19 includes, as shown in FIG. 2, a battery cell 20, a self-check portion 21, a control portion 22, and a switch 23. The control portion 22 and the emergency call control portion 15 are connected by a communication standard, such as CAN (Controller Area Network).

The battery cell 20 is made of a primary battery, and is connected to the emergency call ECU 2 via the switch 23. At the same time, the battery cell 20 supplies electric power to the self-check portion 21 and the control portion 22.

The self-check portion 21 includes, for example, a CPU, a ROM, a RAM, and a data bus that provides connection therebetween, and the CPU executes certain processes in accordance with programs stored in the ROM. The self-check portion 21 regularly checks the electric power supplied from the battery cell 20 to detect a capacity of the battery cell 20, and transmits the detection result to the control portion 22. When the detection result indicates abnormal, the emergency call control portion 15 turns on the indicator 5 to report the occupant of the abnormality of the back-up battery 19 in order to urge the occupant to replace the back-up battery 19.

The control portion 22 includes, for example, a CPU, a ROM, a RAM and a data bus that provides connection therebetween, and the CPU executes certain processes in accordance with programs stored in the ROM. The control portion 22 transmits the capacity detection result of the battery cell 20 to the emergency call control portion 15 based on the capacity detection result of the battery cell 20 supplied from the self-check portion 21.

Further, the control portion 22 turns on the switch 23 based on the control by the emergency call control portion 15 in the emergency of the vehicle, for example, when the emergency call control portion 15 detects the airbag inflation signal, or when the occupant operates the emergency call switch 4.

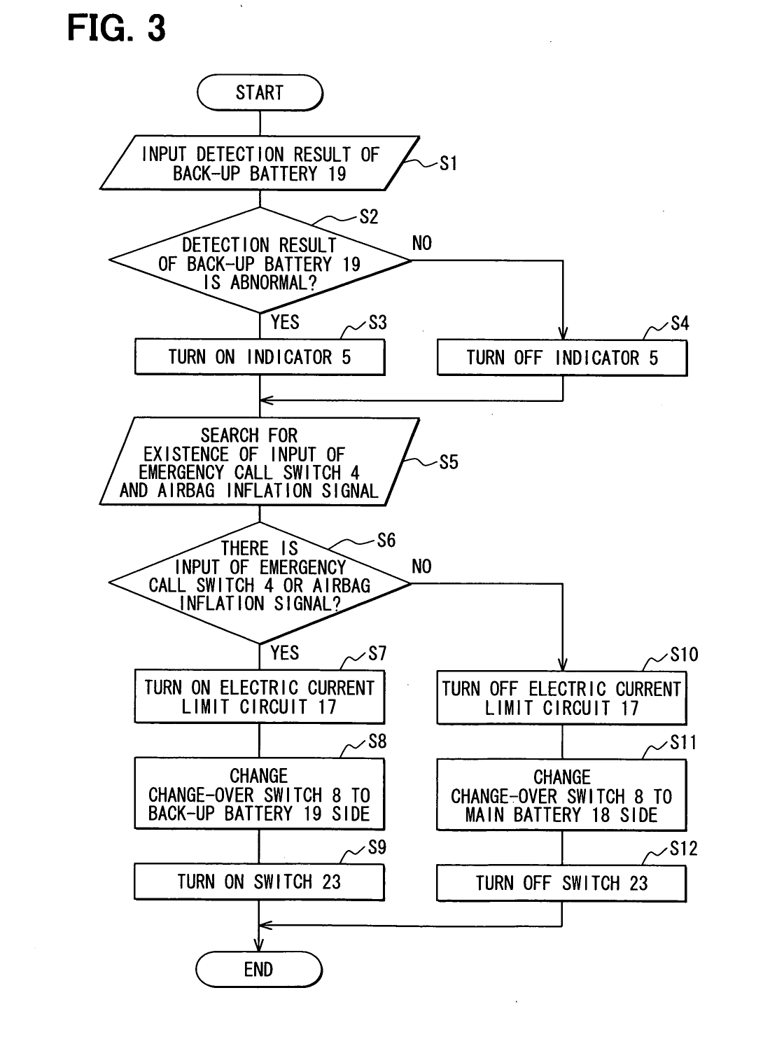

Further, a control process of the emergency call system according to the present invention is described with reference to a flow chart. FIG. 3 is a flow chart showing the control process of the emergency call system according to the present invention. Note that, FIG. 3 exclusively shows controls relating to a self check of the back-up battery 19, the change over of the power supply source in the emergency, and electric current limitation of the drive means.

At S1, the emergency call control portion 15 of the emergency call ECU 2 obtains via the control portion 22 a detection result of the capacity of the battery cell 20 of the back-up battery 19, the detection result being regularly obtained by the self-check portion 21. At S2, the emergency call control portion 15 determines whether abnormality occurs to the detection result of the back-up battery 19, in other words, whether the detection result of the back-up battery 19 indicates equal to or less than a certain capacity and thereby requiring replacement.

At S2, when the emergency call control portion 15 determines that the back-up battery 19 is abnormal, control proceeds to S3, where the emergency call control portion 15 turns on the indicator 5 to report the occupant of the abnormality of the back-up battery 19 in order to urge the occupant to replace the back-up battery 19. At S2, if the emergency call control portion 15 does not determine that the back-up battery 19 is abnormal, control proceeds to S4, where the emergency call control portion 15 turns off the indicator 5.

Then, at S5, the emergency call control portion 15 searches for an existence of the airbag inflation signal and input of the emergency call switch 4 by the occupant, and at S6, when the emergency call control portion 15 detects the input through the operation of the emergency call switch 4 by the occupant, or detects the airbag inflation signal, control proceeds to S7, where the emergency call control portion 15 turns on the control of the electric current control circuit 17 to limit the input electric current of the electric power supplied to the speaker amplifier 16. Further, control proceeds to S8, where the emergency call control portion 15 changes the change-over switch 8 to the back-up battery 19 side, and control proceeds to S9, where the emergency call control portion 15 turns on the switch 23 via the control portion 22.

At S6, when the emergency call control portion 15 does not detect the input through the operation of the emergency call switch 4 by the occupant, or does not detect the airbag inflation signal, control proceeds to S10, where the emergency call control portion 15 turns off the control of the electric current control circuit 17, and further, control proceeds to S11, where the emergency call control portion 15 changes the change-over switch 8 to the main battery 18 side. Further, control proceeds to S12, where the emergency call control portion 15 turns off the switch 23 via the control portion 22.

According to the present embodiment realized by the above control, advantages below can be achieved.

According to the present embodiment, in the emergency, the emergency call control portion 15 detects the input through the operation of the emergency call switch 4 by the occupant or the airbag inflation signal, and only the input electric current of the electric power supplied to the speaker amplifier 16 that drives the speaker 6 is limited by the electric current limit circuit 17 based on the control of the emergency call control portion 15. In other words, the input electric current of the electric power supplied to the CODEC portion 13 is not limited. Due to the above, without reducing an amplification factor of the sound signal supplied through the CODEC portion 13, the electric power consumption by the hands-free communication device (communication means), which includes the speaker 6, the microphone 7, the speaker amplifier 16, and the CODEC portion 13 as main components, can be reduced.

Furthermore, according to the present embodiment, compared with a case where a total electric power of the CODEC portion 13 and the speaker amplifier 16 is limited, the amplification factor itself of the sound signal is prevented from becoming smaller. Thus, a failure in the communication between the occupant and the center can be limited. More specifically, because a peak of the sound signal, which has been amplified to drive the speaker 6, is cut, the sound signal may be distorted. However, because a peak of a human voice does not last for a long time, the electric power consumption of the hands-free communication device can be reduced while the failure in the communication between the occupant and the center is limited.

Therefore, by reducing the electric power consumption in an emergency and by minimizing the capacity of the back-up battery 19, the back-up battery 19 can be reduced in size or the number of cells. In addition, even when the capacity of the back-up battery 19 is designed to be larger in consideration of an operation during a low temperature, size or the number of the cells can be made as small as possible.

Also, compared with a case, where the emergency call control portion 15 outside the back-up battery 19 counts an operating time of the battery cell 20, a count by the emergency call control portion 15 is not required to be reset when the back-up battery 19 is replaced halfway, because the self-check portion 21 is provided inside the back-up battery 19 to regularly check the capacity of the battery cell 20.

Also, because the checking of the capacity of the back-up battery 19 can more accurately tell a state of the battery cell 20 of the back-up battery 19 than the counting of the operating time, replacement time for replacing the back-up battery 19 can be accurately detected and be reported to the occupant. Due to the above, the back-up battery 19 can be replaced at a more appropriate time, and a running cost can be reduced.

Furthermore, according to the present embodiment, the switch 23, which chooses ON and OFF of the output, is provided inside the back-up battery 19, and the emergency call control portion 15 detects the input through the operation of the emergency call switch 4 by the occupant, or the detection of the existence of the airbag inflation signal in an emergency. Only when the switch 23 is turned on based on the control by the emergency call control portion 15, the electric power is supplied to the emergency call ECU 2 from the back-up battery 19. Therefore, from the back-up battery 19, the electric power is prevented from being always outputted from the battery cell 20 of the back-up battery 19 to the emergency call ECU 2, and thereby the electric power of the battery cell 20 is limited from being consumed due to other reasons other than deterioration.

Also, because the electric power of the battery cell 20 is limited from being consumed due to other reasons other than deterioration, an interval itself of the self check can be prolonged. Also, because the switch 23 is provided, smoke or ignition due to a short circuit formed at a wire between the back-up battery 19 and the emergency call ECU 2 can be prevented.

Although preferred embodiments of the present invention has been described in detail as above, the present invention is not limited to the above embodiments, and modification and replacement can be given to the above embodiments without departing form the scope of the present invention.

For example, in the present invention, although the hands-free communication device is used as the communication means, a handset communication device can also be employed. Also in the above case, the electric current of the drive means of the sound output means is limited such that the electric power consumption in an emergency can be reduced. In other words, the present invention can be applied to any device as long as the any device has the sound output means and the drive means.

Further, a configuration of the present invention, in which electric current limiting means is provided for limiting the electric current of the drive means of the sound output means, can be applied to any system other than the emergency call system, as long as the any system changes the power supply source from a main battery to a back-up battery in an emergency and also electric power consumption of the any system is required to be reduced in the emergency.

The present invention relates to an emergency call system that detects a lane changing of a running vehicle, and because the electric power consumption of the emergency call system in an emergency can be reduced, the failure in the communication between the occupant and the center can be limited. Because the back-up battery can be minimized in the capacity and in size or the number of the cells, the present invention can be advantageously applied to various vehicles, such as a passenger car, a truck, a bus.

Although the present invention is disclosed with reference to the preferred embodiments, it is appreciated that the present invention is not limited to the preferred embodiments and the configuration thereof. The present invention is intended to include various modifications and equivalent arrangements. In addition to the above, a scope of the present invention includes a preferred or other various combination or example having or not having merely one of the components.

1. An emergency call system comprising:
emergency call means for performing an emergency call to a center in an emergency of a vehicle;
communication means for communicating with the center, wherein the communication means includes sound output means and drive means for driving the sound output means;
change-over means for changing a power supply source from a main power source to an auxiliary power source; and
electric current limiting means for limiting an electric current of the drive means when the change-over means changes the power supply source to the auxiliary power source.

2. The emergency call system according to claim 1, wherein:
the change-over means changes the power supply source from the main power source to the auxiliary power source in the emergency of the vehicle.

3. The emergency call system according to claim 1, wherein:
the electric current limiting means limits only the electric current of the drive means when the change-over means changes the power supply source to the auxiliary power source.
